(19) United States
(12) Patent Application Publication
(10) Pub. No.: US 2008/0032113 A1
(43) Pub. Date: Feb. 7, 2008

(54) Glazing and Film Functional Coatings Having a Porous Inorganic Layer and a Polymeric Filler

(76) Inventors: Jaime Antonio Li, Martinsville, VA (US); Coby Lee Hubbard, Bassett, VA (US); James Peyton Enniss, Martinsville, VA (US)

Correspondence Address: BRENC LAW;ANDREW BRENC, P.O. BOX 155, ALBION, PA, 16401-0155, US

(21) Appl. No.: 11/871,159

(22) Filed: Oct. 12, 2007

Related U.S. Application Data
(62) Division of application No. 11/253,125, filed on Oct. 18, 2005.

(51) Int. Cl. B32B 5/18; B29D 11/00; B32B 3/06

(52) U.S. Cl. 428/307.3; 427/160

(57) ABSTRACT

Now, according to the present invention, functional coatings are provided that comprise both a porous inorganic layer and a polymeric filler. The porous inorganic layer comprises an inorganic material that can be formed into a layer at relatively low heat load. The polymeric filler fills the porosities in the porous inorganic layer, and can be, for example, wet coated onto the porous inorganic layer. The resulting functional coatings offer simpler and cheaper fabrication along with improved physical and optical performance.

### CROSS-REFERENCE TO RELATED APPLICATIONS

This application claims priority to and is a divisional application of copending U.S. application Ser. No. 11/253,125 filed on Oct. 18, 2005, which is hereby incorporated by reference in its entirety.

### FIELD OF THE INVENTION

The present invention is in the field of glazing and film functional coatings, and specifically the present invention is in the field of glazing and film functional coatings that provide physical and thermal performance enhancement.

### BACKGROUND

Polymeric, transparent glazing films that can be disposed directly on the surface of window panes, either before or after installation of the pane in a frame, have been used to reduce the amount of electromagnetic radiation of various wavelengths passing through the panes. For example, glazing films have been used on the interior surfaces of windows to reflect infrared radiation back into a room, thereby preventing heat loss through the window. These films, which are known as low emissivity films, are used in many household and commercial window applications.

Glazing films can have a variety of film structures. For example, one common type of film is a laminate structure having a base layer, such as a poly(ethylene terephthalate) sheet, upon which a relatively thin, transparent, metallized layer has been deposited. A protective layer, which is conventionally known as a scratch resistant coating or hardcoat, can then be deposited over the metallized layer to form the finished film, which can then be bonded to a glazing panel.

Conventional films often employ a polymer hard coat over a film to add optical or scratch resistance properties. However, for heat reflecting applications, the polymer hard coat layer typically is a relatively thick layer of polymer that absorbs infrared radiation, thereby reducing the effectiveness of any underlying infrared reflecting layer. It is also possible to apply inorganic hard coats; however, the deposition of inorganic hard materials often require high process temperatures, resulting in higher costs and fewer processing options.

There is therefore a need in the art for functional coatings that provide the desired optical and/or mechanical effect without the drawbacks found in conventional polymer coatings. There is also a need for functional coatings that can be formed at relatively low heat loads.

### SUMMARY OF THE INVENTION

Now, according to the present invention, functional coatings are provided that comprise both a porous inorganic layer and a polymeric filler. The porous inorganic layer comprises an inorganic material that can be formed into a layer at relatively low heat load. The polymeric filler fills the porosities in the porous inorganic layer, and can be, for example, wet coated onto the porous inorganic layer. The resulting functional coatings offer simpler and cheaper fabrication along with improved physical and optical performance.

### BRIEF DESCRIPTION OF THE FIGURES

FIG. 1 is a schematic representation of a cross section of one embodiment of a functional coating of the present invention disposed on a glazing film substrate.

### DETAILED DESCRIPTION

The present invention provides glazing and film functional coatings that can be used as a scratch resistant physical barrier that combines excellent abrasion resistance with high infrared transparency. Scratch resistance is desirable because the surface of the film that faces the interior of an enclosed space, such as a room, can be damaged by mechanical abrasion and other deleterious events. Infrared transparency is desirable when used with low emissivity glazing films because absorption of infrared radiation by a functional coating can result in heat loss from an enclosed space. Although the functional coatings described herein are particularly well suited for use in low emissivity glazing film applications, it will be understood by those of skill in the art that there are many other glazing film applications for which functional coatings of the present invention can be suitably used.

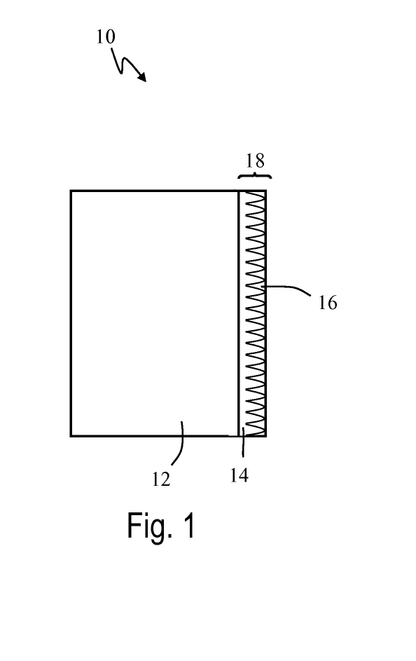

As shown in FIG. 1 generally at 10, in various embodiments of the present invention a glazing film comprises a glazing film substrate 12 with a functional coating 18 of the present invention disposed thereon. The glazing film substrate 12, as will be described in detail below, can comprise many thermoplastic polymers, and can have a infra-red reflecting coating (not shown) incorporated on one or both surfaces. The infra-red reflecting coating can function to reflect infrared radiation and prevent heat loss out of a living space.

As further shown in FIG. 1, the functional coating 18 comprises a porous inorganic layer 14 disposed in contact with the glazing film substrate 12, and a polymeric filler 16 disposed in contact with the porous inorganic layer 14 opposite the glazing film substrate 12.

The porous inorganic layer of the present invention can be any suitable inorganic material that is sufficiently hard to afford scratch resistance, that is optically acceptable, and that absorbs little or no infrared radiation.

The inorganic material can be, for example, transparent or nearly so. Examples of materials that can be used include YF₃, AlF₃, CaF₂, CeF₃, LaF₃, Na₃AlF₆, MgF₂, BaF₂, Al₂O₃ and the like, as well as silicon oxides, and specifically SiO_{1.5}, SiOₓ (where x is from 1 to 2) or a combination of the foregoing. In various embodiments, the porous inorganic layer comprises a silicon oxide, and in some embodiments, the porous inorganic layer comprises SiO_{1.5} or SiOₓ (where x is from 1 to 2).

The porous inorganic layer can be applied to a glazing film substrate with any suitable technique. In various embodiments, the porous inorganic layer is applied to the glazing film substrate using physical vapor deposition (PVD), and specifically, evaporation. This technique is typically performed at relatively low heat loads, and high deposition rates, which offers cost savings and greater processing flexibility. In various embodiments, the porous inorganic layer is formed at a heat load that does not cause distortion of the glazing film substrate.

The average thickness of the porous inorganic layer, in various embodiments, will vary depending on the desired result. In various embodiments the porous inorganic layer can be relatively thin, for example, less than 1 micron, less than 0.8 microns, less than 0.5 microns, less than 0.3 microns, or less than 0.1 microns.

The porous inorganic layer, after formation, will define “porosities,” which are unfilled regions within the layer. These porosities can be measured indirectly by measuring the rate at which moisture penetrates through the layer. After formation of the porous inorganic layer on a glazing film substrate, the porosities are filled with a polymeric filler, as described below. In preferred embodiments, the polymeric filler is applied so as to just fill the porosities or just slightly overfill the porosities without forming a substantial additional layer on top of the porous inorganic layer.

The polymeric filler of the present invention can comprise any suitable composition that is capable of filling the porosities of the porous inorganic layer and that has minimal infrared absorption. The polymeric filler can comprise any additive or agent that is commonly employed to improve hardcoat quality, including, for example, hard particles that serve to improve scratch resistance. In various embodiments, a polymeric filler comprises any of the polymer materials disclosed in U.S. Pat. No. 4,557,980 to Hodnett.

Thermoplastic, thermoset, or cross linked polymer materials that function as a protective layer, such as a acrylate and urethane hardcoats, can be used as a polymeric filler material. Further examples of useful hardcoat materials that can be used in the polymeric fillers of the present invention include radiation cured products, such as ultraviolet or electron beam cured products, and thermally cured coating products resulting from heat or plasma treatment.

Another useful class of materials for filling the porous inorganic layer are the inorganic and organic-inorganic hybrid coating materials formed by the hydrolysis and condensation product of organo alkoxy silanes and non-organic silane materials commonly employed in sol gel coating chemistry.

Hardcoat materials that are useful for polymeric filler coatings of the present invention further include acrylate or (meth)acrylate functional groups attached to structures, such as a polyester, polyether, acrylic, epoxy, urethane, alkyd, spiroacetal, polybutadiene or other resins and frequently have relatively low molecular weight. Also referred to as oligomer or prepolymers they can contain a relatively large amount of a polyfunctional compounds for high crosslink density for hardness and for diluting the viscosity.

In various embodiments of the present invention, the polymer filler comprises an epoxy functionality, vinyl ether functionality, silane functionality, or acrylate functionality.

Polyfunctional monomers such as trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate or neopentyl glycol di(meth)acrylate, or mixtures and combinations of any of the foregoing are common and useful.

Other hardcoats, as are known in the art, can be used as polymeric fillers of the present invention. In various embodiments, a polymeric filler of the present invention comprises a member selected from the group consisting of epoxies, vinyl ethers, vinyl esters, and mixtures thereof, which are cured by ultraviolet light activating photoinitiators yielding cationic chemical curing agents.

Polymer filler compositions of the present invention, as defined herein, include organically modified and unmodified sol gel, and the polymer fillers described herein can also further include the addition of various inorganic particles which can further improve the hardness of the polymer filler layer and hence the hardness of the combined polymer filler layer and the porous inorganic layer.

The polymeric filler of the present invention can be applied to the porous inorganic layer in any suitable manner that results in the filling of the porosities defined by the porous inorganic layer. The polymeric filler, upon application to the porous inorganic layer, will tend to fill any porosities that are present in the porous inorganic layer, thereby forming a relatively continuous functional coating surface. The polymeric filler can be applied so as to fill available porosities, or to fill available porosities and further form a thin, continuous polymeric filler region over the porous inorganic layer with filled porosities. The polymeric filler can be applied, for example, by wet coating, monomer evaporation, gravure, screen, spray, spin or other deposition techniques. The polymeric filler may then undergo reaction if necessary by exposure to the appropriate initiation source such as, but not limited to, ultraviolet radiation, thermal radiation, or plasma treatment.

Together the porous inorganic layer and the polymeric filler form the functional coating. This functional coating will absorb relatively little infrared radiation because of the relatively low volume fraction of polymer filler that is used to complete the layer after formation of the porous inorganic layer. Further, because the porous inorganic layer can provide greater scratch resistance than an equivalent amount of organic filler, the overall thickness of the scratch resistant layer can be less than the thickness of conventional layers that provide approximately equal scratch protection.

In various embodiments, the functional coating of the present invention has an overall thickness of less than 15 microns, less than 10 microns, less than 5 microns, less than 3 microns, or less than 1 micron. For any of these thicknesses, the porous inorganic layer can comprise over 50%, 60%, or 70% of the functional coating, measured as a volume.

The glazing film substrate 12 shown in FIG. 1 and described herein can be any suitable thermoplastic film that is used in glazing film manufacture. In various embodiments, the thermoplastic film can comprise polycarbonates, acrylics, nylons, polyesters, polyurethanes, polyolefins such as polypropylene, cellulose acetates and triacetates, vinyl acetals, such as poly(vinyl butyral), vinyl chloride polymers and copolymers and the like, or another plastic suitable for use in a performance film. In various embodiments, a glazing film substrate can comprise a poly(ethylene terephthalate) substrate on which is disposed an infrared reflecting coating.

In various embodiments, the thermoplastic film is a polyester film, for example poly(ethylene terephthalate). In various embodiments the thermoplastic film can have a thickness of 0.012 mm to 0.40 mm, preferably 0.025 mm to 0.1 mm, or 0.04 to 0.06 mm. The thermoplastic film can include a performance coating, which is typically applied to a surface of the film and which can be a metallized layer, to improve one or more properties, such as infrared radiation reflection or to provide for conductivity. These performance layers can include, for example, a multi-layer stack (for example, may comprise dielectric/metal/dielectric stacks using any suitable materials) for reflecting infra-red radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers. The performance layer can include, where appropriate, a primer layer to facilitate bonding of metallized layers to the polymeric substrate, to provide strength to the substrate, and/or to improve the planarity. Further, the performance layer can also comprise any suitable metal in the metallized layer, as is known in the art, for example, silver, copper, aluminum, alloys of the foregoing, and the like, and can be applied using known sputtering and vapor deposition techniques, for example. Other suitable layers can be used, as is known in the art (see, for example, U.S. Pat. No. 6,451,414).

The glazing film substrates, in some embodiments, are optically transparent (i.e. objects adjacent one side of the layer can be comfortably seen by the eye of a particular observer looking through the layer from the other side). In various embodiments, the glazing film substrate comprises materials such as re-stretched thermoplastic films having the noted properties, which include polyesters. In various embodiments, poly(ethylene terephthalate) is used, and, in various embodiments, the poly(ethylene terephthalate) has been biaxially stretched to improve strength, and has been heat stabilized to provide low shrinkage characteristics when subjected to elevated temperatures (e.g. less than 2% shrinkage in both directions after 30 minutes at 150° C.).

Various coating and surface treatment techniques for poly(ethylene terephthalate) film that can be used with the present invention are disclosed in published European Application No. 0157030. Films of the present invention can also include an antifog layer, as are known in the art.

As used herein and as shown as element 12 in FIG. 1, a “glazing film substrate” includes multiple layer constructs as well as single layer and coextruded films. For example, two or more separate polymeric layers that are laminated, pressed, or otherwise bound together to form a glazing film can be glazing film substrates upon which functional coatings of the present invention can be disposed.

Useful example of glazing film substrates that can be used with the present invention include those described in U.S. Pat. Nos. 6,049,419 and 6,451,414, and U.S. Pat. Nos. 6,830,713, 6,827,886, 6,808,658, 6,783,349, and 6,569,515.

In various embodiments the functional coatings of the present invention will allow transmission of at least 85%, at least 90%, at least 95% or at least 99% of heat, black body, or in general infrared radiation between the wavelengths of 5 microns and 25 microns.

The present invention includes methods of forming any of the functional coatings of the present invention on a glazing film at a heat load less than the distortion point of the film. In various embodiments of these methods, a functional coating can be formed using evaporation on films less than 25.4 microns (1 mil) in thickness or less than 6.35 microns (¼ mil) in thickness.

Films of the present invention can also include a hard or planarizing layer that is added, for example, below an infrared reflection layer. Such hard or planarizing layers, which are known in the art, can be, for example, from 2 to 8 microns in thickness.

For any of the embodiments described above for which a functional coating of the present invention is disposed on a film substrate, there is an equivalent embodiment, where appropriate, in which the functional coating is disposed directly on a rigid substrate such as glass or rigid plastic. In these embodiments, functional coating can be formed on glass or rigid plastics in the same manner as on films. The glass can be any conventionally used glass, including, for example, solar glass and other modified glasses, and the rigid substrates can include functional layers, such as a metallized layer, on which the functional coating of the present invention are formed. Rigid plastics can comprise acrylic such as Plexiglass®, polycarbonate such as Lexan®, and other plastics, that are conventionally used as glazings.

The present invention includes glazings, and specifically glass windows, that comprise a glazing film comprising a functional coating of the present invention.

The present invention includes glazing that comprise a rigid glazing substrate having disposed on a surface a functional coating of the present invention.

The present invention includes methods of forming a functional coating comprising forming a porous inorganic layer on a glazing film substrate wherein the porous inorganic layer defines porosities and then disposing an polymeric filler on said porous inorganic layer, thereby filling the porosities.

The present invention also includes methods of manufacturing a glazing comprising forming any of the functional coatings of the present invention directly on a glazing substrate, such as a rigid glass or plastic substrate.

The present invention also includes methods of manufacturing a glazing film comprising forming any of the functional coatings of the present invention on a glazing film substrate.

The present invention further includes methods of forming a functional coating and of manufacturing glazing films having those functional coatings at a heat load that does not cause distortion of the glazing film.

The present invention also includes methods of preventing heat loss from an enclosed space, comprising disposing a glazing film having a functional coating of the present invention on a window adjacent the enclosed space.

The present invention includes shades having disposed thereon functional coatings of the present invention.

The present invention includes safety bilayer glass panels, which are generally constructed with the following layer organization: glass layer//polymer sheet//glazing film. In these bilayer glass panels, the polymer sheet can be any suitable thermoplastic material, and, in various embodiments, the polymer sheet comprises plasticized poly(vinyl butyral) (PVB). In this bilayer embodiment, the glazing film can be any of the glazing films described herein comprising a functional coating of the present invention. The bilayer can be formed using any conventional technique, including using a second, temporary pane of glass disposed in contact with the functional coating to allow for lamination of the bilayer, with subsequent removal of the temporary pane of glass after the lamination process bonds the other layers together into the bilayer.

Emittance, as used herein, can be measured using NFRC 301-93 “Standard Test Method for Emittance of Specular Surfaces Using Spectrometric Measurements.”

The techniques and functional coatings of the present invention now make it possible to more economically produce functional coatings that, among other desirable characteristics, can provide corrosion resistance, scratch resistance, and infrared transparency.

Although embodiments of the present invention have been described herein, it will be clear to those of ordinary skill in the art that many other permutations are possible and are within the scope and spirit of the present invention. In addition, many modifications may be made to adapt a particular situation or material to the teachings of the invention without departing from the essential scope thereof. Therefore, it is intended that the invention not be limited to the particular embodiments disclosed herein for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout.

Any figure reference numbers given within the abstract or any claims are for illustrative purposes only and should not be construed to limit the claimed invention to any one particular embodiment shown in any figure.

Unless otherwise noted, drawings are not drawn to scale.

Each reference, including journal articles, patents, applications, and books, referred to herein is hereby incorporated by reference in its entirety.

We claim:

1. A glazing film, comprising:
a glazing film substrate;
a layer that reflects infrared radiation; and,
a functional coating, wherein said functional coating comprises:
a porous inorganic layer disposed in contact with said layer that reflects infrared radiation, wherein said porous inorganic layer defines porosities therein throughout; and,
a polymeric filler disposed on said porous inorganic layer, wherein said polymeric filler is disposed within said porosities and forms a continuous layer of said polymeric filler.

2. The glazing film of claim 1, wherein said glazing film substrate comprises poly(ethylene terephthalate).

3. The glazing film of claim 1, wherein said functional coating has a thickness of less than 1 micron.

4. The glazing film of claim 1, wherein said porous inorganic layer comprises a member selected from the group consisting of SiOₓ, BaF₂, YF₃, MgF₂, AlF₃, Al₂O₃, CaF₂, CeF₃, LaF₃, and Na₃AlF₆.

5. The glazing film of claim 1, wherein said porous inorganic layer comprises a member selected from the group consisting of SiOₓ, BaF₂, YF₃, and MgF₂.

6. The glazing film of claim 1, wherein said porous inorganic layer comprises SiOₓ or YF₃.

7. The glazing film of claim 1, wherein said glazing film has an emissivity of less than 0.3.

8. The glazing film of claim 1, wherein said polymeric filler comprises an epoxy functionality, vinyl ether functionality, silane functionality, or acrylate functionality.

9. The glazing film of claim 1, wherein said polymeric filler comprises inorganic particles.

10. The glazing film of claim 1, wherein said layer that reflects infrared radiation is a metallic layer.

11. The glazing film of claim 1, wherein said layer that reflects infrared radiation is a multilayer stack.

12. The glazing film of claim 1, wherein said glazing film substrate comprises a hard or planarizing layer.

13. A method of producing a glazing film, comprising:
providing a glazing film substrate comprising a layer that reflects infrared radiation;
disposing a porous inorganic layer on said layer that reflects infrared radiation, wherein said porous inorganic layer defines porosities therein throughout; and,
disposing a polymeric filler on said porous inorganic layer, thereby filling said porosities with said polymeric filler and forming a continuous layer of said polymeric filler.

14. A glazing, comprising:
a rigid glazing substrate; and,
a glazing film, comprising:
a glazing film substrate;
a layer that reflects infrared radiation; and,
a functional coating, wherein said functional coating comprises:
a porous inorganic layer disposed in contact with said layer that reflects infrared radiation, wherein said porous inorganic layer defines porosities therein throughout; and,
a polymeric filler disposed on said porous inorganic layer, wherein said polymeric filler is disposed within said porosities and forms a continuous layer of said polymeric filler.
